(19) United States
(12) Patent Application Publication
(10) Pub. No.: US 2019/0306509 A1
(43) Pub. Date: Oct. 3, 2019

(54) VIDEO PROCESSING APPARATUS FOR PROCESSING VIDEO DATA CAPTURED BY VIDEO CAPTURING APPARATUS MOUNTED ON VEHICLE

(71) Applicant: PANASONIC INTELLECTUAL PROPERTY MANAGEMENT CO., LTD., Osaka (JP)

(72) Inventor: Haruko TERAI, Osaka (JP)

(73) Assignee: PANASONIC INTELLECTUAL PROPERTY MANAGEMENT CO., LTD., Osaka (JP)

(21) Appl. No.: 16/368,216

(22) Filed: Mar. 28, 2019

(30) Foreign Application Priority Data
Mar. 30, 2018 (JP) 2018-069322

(51) Int. Cl. H04N 19/139; H04N 19/172; H04N 19/132

(52) U.S. Cl. CPC H04N 19/139; H04N 19/132; H04N 19/172

(57) ABSTRACT

The frame vector calculator calculates a frame vector indicating a change in a position of a target object between frames of video data captured by a video capturing apparatus mounted on a vehicle. The low-frequency component extractor extracts low-frequency components of the frame vector, the low-frequency components indicating temporal variations of the frame vector equal to or less than a predetermined frequency. The high-frequency component extractor extracts high-frequency components of the frame vector, the high-frequency components indicating temporal variations of the frame vector higher than the predetermined frequency, based on the low-frequency components of the frame vector. The compensation vector calculator calculates a compensation vector compensating for the variations of the high-frequency components of the frame vector. The video compensator compensates the video data based on the compensation vector.

### BACKGROUND

### 1. Technical Field

The present disclosure relates to a video processing apparatus, a video processing system, a video processing method, and a program for processing video data captured by a video capturing apparatus mounted on a vehicle.

### 2. Description of Related Art

In a case of capturing video or image data by a video capturing apparatus held by a photographer, or by a video capturing apparatus mounted on a moving body such as a vehicle, the captured video or image data may include vibration due to motion applied to the video capturing apparatus (hand movement, shaking of the vehicle, etc.). In order to compensate for such vibration, for example, the following techniques are known.

(1) Moving an optical component(s) of a video capturing apparatus so as to cancel movement applied to the video capturing apparatus.

(2) When a video capturing apparatus is provided with a CMOS sensor, compensating for distortion of a moving object caused by deviation of capturing times at pixels of the CMOS sensor (focal plane distortion compensation).

(3) Calculating a motion vector indicating a direction and a distance of movement of any target object in captured video data, and moving entire video data so as to cancel motion represented by the motion vector.

For example, Japanese Patent Laid-open Publication No. 2015-195453 discloses the technique (3).

According to the above-described technique (3), in order to compensate for vibration of video data by video processing, a video capturing apparatus should captures video data over a capturing area larger than a display area of a display apparatus (or than an area of video data to be finally outputted in some format). If the display area is located within the capturing area, then it is possible to move the entire video data so as to cancel the motion represented by the motion vector. However, when the display area reaches an edge of the capturing area, it is not possible to compensate for the vibration of the video data any more. Therefore, in order to cancel larger motion, a larger capturing area is required, and an amount of data also increases. In addition, when amounts of compensations for cancelling small motions accumulate, the display area may reach the edge of the capturing area. In order to make such a situation to less likely occur, and to surely compensate for the vibration of the video data, a large capturing area (that is, a large amount of data) is required.

Therefore, it is required to surely compensate for the vibration of the video data, while reducing the amount of video data to be captured.

### SUMMARY

One non-limiting and exemplary embodiment is to provide a video processing apparatus capable of compensating for vibration of video data captured by a video capturing apparatus mounted on a vehicle, without requiring an excessively large capturing area.

A video processing apparatus according to an aspect of the present disclosure is provided with a frame vector calculator, a low-frequency component extractor, a high-frequency component extractor, a compensation vector calculator, and a video compensator. The frame vector calculator calculates a frame vector indicating a change in a position of a target object between frames of video data captured by a video capturing apparatus mounted on a vehicle. The low-frequency component extractor extracts low-frequency components of the frame vector, the low-frequency components indicating temporal variations of the frame vector equal to or less than a predetermined frequency. The high-frequency component extractor extracts high-frequency components of the frame vector, the high-frequency components indicating temporal variations of the frame vector higher than the predetermined frequency, based on the low-frequency components of the frame vector. The compensation vector calculator calculates a compensation vector compensating for the variations of the high-frequency components of the frame vector. The video compensator compensates the video data based on the compensation vector.

The video processing apparatus according to the aspect of the present disclosure can compensate for vibration in the video data captured by video capturing apparatus mounted on the vehicle, without requiring an excessively large capturing area, by extracting the high-frequency components of the frame vector and calculating the compensation vector compensating for their variations.

### BRIEF DESCRIPTION OF DRAWINGS

FIG. 1 is a block diagram showing a vehicle 1 provided with a video processing system according to a first embodiment;

FIG. 2 is a block diagram showing a detailed configuration of the video processing system of FIG. 1;

FIG. 3 is a diagram showing vibration appearing in video data captured by a video capturing apparatus 2 of FIG. 1;

FIG. 4 is a diagram showing a state in which a target object 20 is displaced downward in one frame of the video data captured by the video capturing apparatus 2 of FIG. 1;

FIG. 5 is a diagram showing a state in which a display area 21 is moved so as to compensate for the displacement of FIG. 4;

FIG. 6 is a diagram showing a state in which the target object 20 is displaced upward in one frame of the video data captured by the video capturing apparatus 2 of FIG. 1;

FIG. 7 is a diagram showing a state in which the display area 21 is moved so as to compensate for the displacement of FIG. 6;

FIG. 8 is a diagram showing a state in which the display area 21 has reached an edge of a capturing area 22 in one frame of the video data captured by the video capturing apparatus 2 of FIG. 1;

FIG. 9 is a diagram schematically showing processing of a frame vector by the video processing system of FIG. 1;

FIG. 10 is a block diagram showing a configuration of a video processing system according to a second embodiment; and

FIG. 11 is a flowchart showing vibration compensation process executed by a computer 32 of FIG. 10.

### DETAILED DESCRIPTION

Hereinafter, embodiments will be described in detail with reference to the drawings as appropriate. However, excessively detailed explanation may be omitted. For example, detailed explanation of well-known matters may be omitted, and redundant explanations on substantially the same configuration may be omitted. This is to avoid the unnecessary redundancy of the following description, and to facilitate understanding by those skilled in the art.

It is to be noted that the inventor(s) intends to provide the accompanying drawings and the following description so that those skilled in the art can sufficiently understand the present disclosure, and does/do not intend to limit subject matters recited in the claims.

### First Embodiment

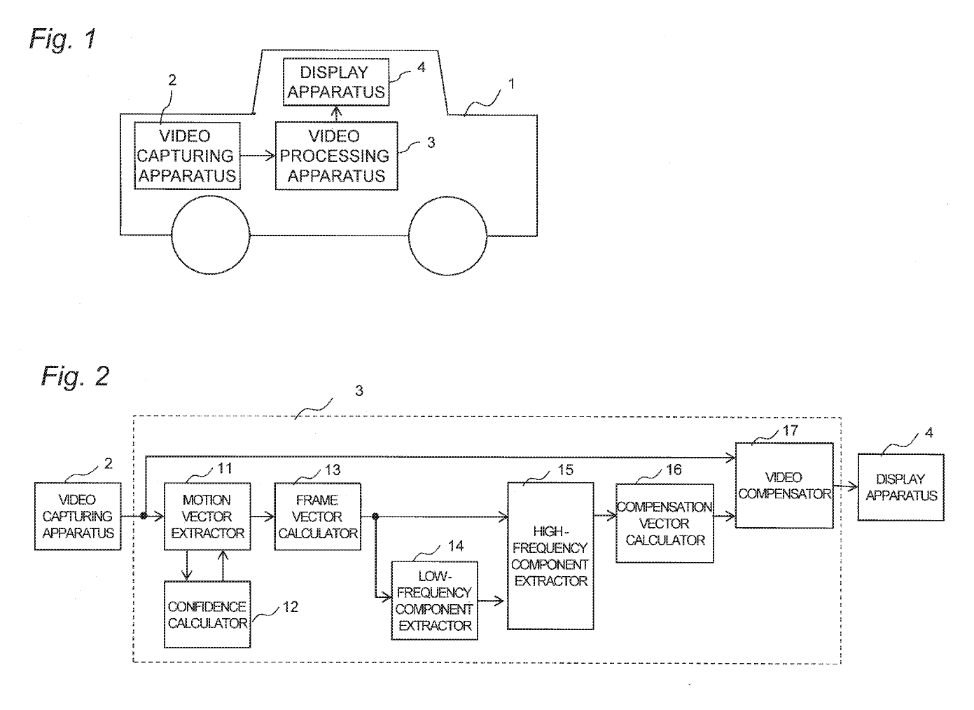

Hereinafter, with reference to FIGS. 1 to 9, a video processing system according to a first embodiment will be described.

[1-1. Configuration]

FIG. 1 is a block diagram showing a vehicle 1 provided with a video processing system according to the first embodiment. The vehicle 1 is provided with a video capturing apparatus 2, a video processing apparatus 3, and a display apparatus 4.

The vehicle 1 is, for example, an automobile.

The video capturing apparatus 2 includes one or more cameras fixed at various positions of a body of the vehicle 1. The video capturing apparatus 2 may further perform one or more preprocessing, such as conversion from RGB to another color space (such as YUV), adjustment of luminance, adjustment of contrast, etc., before sending captured video data to the video processing apparatus 3.

The video processing apparatus 3 processes the video data captured by the video capturing apparatus 2, so as to compensate for vibration caused by motion applied to the video capturing apparatus 2.

FIG. 2 is a block diagram showing a detailed configuration of the video processing system of FIG. 1. The video processing apparatus 3 is provided with a motion vector extractor 11, a confidence calculator 12, a frame vector calculator 13, a low-frequency component extractor 14, a high-frequency component extractor 15, a compensation vector calculator 16, and a video compensator 17.

The motion vector extractor 11 extracts a motion vector from frames of video data captured by the video capturing apparatus 2. The motion vector extractor 11 divides each frame into a plurality of blocks composed of, for example, 32×32 pixels, and matches each block of a current frame with each block of an immediately preceding frame, thus extracting a motion vector of each block.

When a plurality of motion vectors is extracted in a certain frame, the confidence calculator 12 calculates confidences of the motion vectors in order to determine which of the motion vectors corresponds to a frame vector indicating motion of an entire frame.

The frame vector calculator 13 calculates a frame vector indicating motion of the entire frame, based on the motion vectors and their confidences. The frame vector indicates a change in a position of some target object between the frames.

The low-frequency component extractor 14 extracts low-frequency components of the frame vector, the low-frequency components indicating temporal variations of the frame vector equal to or less than a predetermined frequency “f”. In this case, the predetermined frequency “f” is set to be equal to or less than a frequency of vibration well perceivable and obstructive to human, and, for example, set to about 1 Hz. The low-frequency component extractor 14 smoothes temporal variations of the frame vector, for example, by calculating an average direction and an average magnitude of the frame vector over a current frame and at least one immediately preceding frame, and thus, extracts low-frequency components.

The high-frequency component extractor 15 extracts high-frequency components of the frame vector, the high-frequency components indicating temporal variations of the frame vector higher than the predetermined frequency “f”, based on the low-frequency components of the frame vector.

The compensation vector calculator 16 calculates a compensation vector compensating for variations in the high-frequency components of the frame vector.

The video compensator 17 compensates the video data captured by the video capturing apparatus 2, so as to compensate for the variations of the high-frequency components of the frame vector based on the compensation vector.

The video processing apparatus 3 may be implemented by dedicated hardware, or implemented as software executed by a general-purpose processor.

The video processing apparatus 3 processes and outputs each frame of the video data captured by the video capturing apparatus 2, for example, within a duration corresponding to one frame.

The display apparatus 4 displays the video data compensated by the video compensator 17. When the video capturing apparatus 2 includes a camera capturing the rear of the vehicle 1, the video capturing apparatus 2, the video processing apparatus 3, and the display apparatus 4 function as electronic mirrors.

The video capturing apparatus 2, the video processing apparatus 3, and the display apparatus 4 constitute the video processing system.

[1-2. Operation]

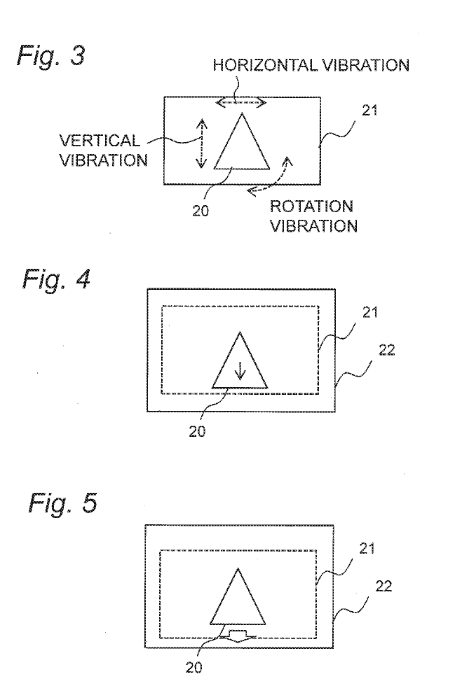

First, referring to FIGS. 3 to 8, a principle of compensating for vibration of video data by video processing will be described.

FIG. 3 is a diagram showing vibration appearing in video data captured by the video capturing apparatus 2 of FIG. 1. A display area 21 of the video data displayed on the display apparatus 4 includes a target object 20. The target object 20 may receive horizontal vibration, vertical vibration, and/or rotational vibration between frames, due to motion applied to the video capturing apparatus 2.

As shown in FIGS. 4 to 8, in order to compensate for the vibration of the video data by the video processing, the video capturing apparatus 2 captures video data over a capturing area 22 larger than the display area 21 of the display apparatus 4. The video processing apparatus 3 outputs only the display area 21 included in the capturing area 22, to the display apparatus 4.

FIG. 4 is a diagram showing a state in which the target object 20 is displaced downward in one frame of the video data captured by the video capturing apparatus 2 of FIG. 1. FIG. 5 is a diagram showing a state in which the display area 21 is moved so as to compensate for the displacement of FIG. 4. When the target object 20 is displaced downward, it is possible to compensate displacement of the target object 20 by moving the display area 21 downward within the capturing area 22.

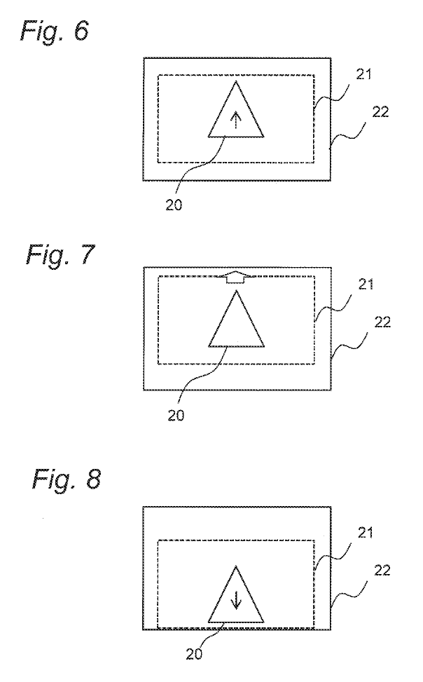

FIG. 6 is a diagram showing a state in which the target object 20 is displaced upward in one frame of the video data captured by the video capturing apparatus 2 of FIG. 1. FIG. 7 is a diagram showing a state in which the display area 21 is moved so as to compensate for the displacement of FIG. 6. When the target object 20 is displaced upward, it is possible to compensate displacement of the target object 20 by moving the display area 21 upward within the capturing area 22.

FIG. 8 is a diagram showing a state in which the display area 21 has reached an edge of the capturing area 22 in one frame of the video data captured by the video capturing apparatus 2 of FIG. 1. For example, when the vehicle 1 continuously moves in a certain direction (for example, traveling along a long curve), or when the target object 20 occupying most of the capturing area 22 continuously moves in a certain direction, the display area 21 may reaches the edge of the capturing area 22 by repeating the compensation. When the display area 21 has reached a lower edge of the capturing area 22, even if the target object 20 is displaced downward, the display area 21 cannot be moved further downward within the capturing area 22. Therefore, in the state of FIG. 8, displacement of the target object 20 cannot be compensated.

The video display system according to the first embodiment avoid the state as shown in FIG. 8, and surely compensates for the vibration of the video data, without requiring the excessively large capturing area 22.

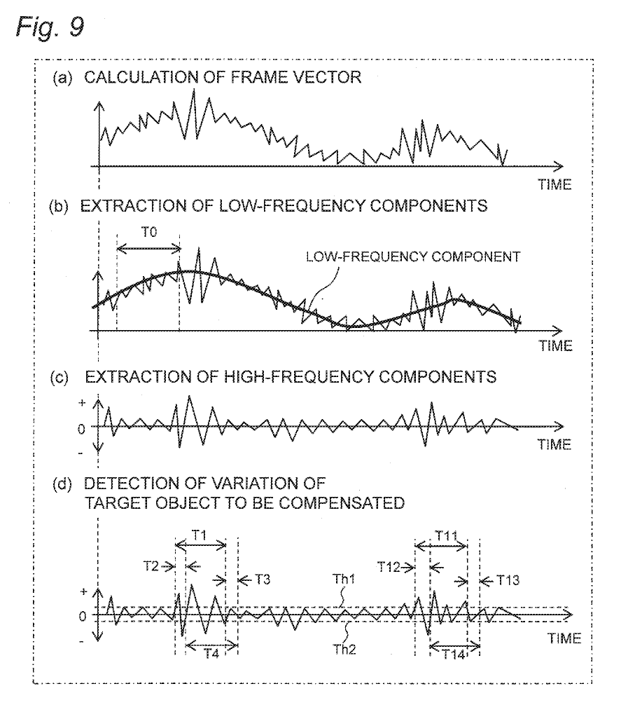

Next, with reference to FIG. 9, vibration compensation by the video display system according to the first embodiment will be described.

FIG. 9 is a diagram schematically showing processing of a frame vector by the video processing system of FIG. 1.

FIG. 9(a) shows a temporal variation of the frame vector calculated by the frame vector calculator 13. Each of vertical axes of FIGS. 9(a) to 9(d) shows a magnitude of a variation of only one component of the frame vector (horizontal vibration, vertical vibration, or rotational vibration).

FIG. 9(b) shows low-frequency components of the frame vector extracted by the low-frequency component extractor 14. The low-frequency component extractor 14 extracts low-frequency components of the frame vector varying slower than the predetermined frequency “f”, that is, a unit duration of T0=1/f. The low-frequency components of the frame vector arise from, for example, a curve, a gradient, or a gentle asperity of a road. Since slow vibration of the video data is less likely to deteriorate visibility, the video processing apparatus 3 ignores the low-frequency components of the frame vector, and compensates for only vibration of the high-frequency components of the frame vector, as described below.

FIG. 9(c) shows the high-frequency components of the frame vector extracted by the high-frequency component extractor 15. The high-frequency components of FIG. 9(c) are obtained by superposing a signal canceling the low-frequency components of FIG. 9(b), on the frame vector of FIG. 9(a).

FIG. 9(d) shows a variation of a target object to be compensated, which is detected in the high-frequency components of the frame vector of FIG. 9(c).

The compensation vector calculator 16 calculates a compensation vector compensating for variations in the high-frequency components of the frame vector. By compensating for only the vibration of the high-frequency components of the frame vector, it is possible to ignore the slow vibration of the video data, which does not significantly affect the visibility. Even if the slow vibration of the video data which does not significantly affect the visibility occurs, the vibration is not compensated. Thus, the display area 21 is less likely to reach the edge of the capturing area 22.

In order to detect the variations of the target object to be compensated, the compensation vector calculator 16 may operate as follows.

For an amount of variations of the high-frequency components of the frame vector, a positive threshold value Th1 and a negative threshold value Th2, having an identical absolute value to each other, are set. When the absolute value of the amount of variations of the high-frequency components of the frame vector becomes equal to or larger than predetermined threshold values Th1=−Th2, the compensation vector calculator 16 calculates a compensation vector compensating for the variations. Referring to an example of FIG. 9(d), the absolute value of the amount of variations of the high-frequency components of the frame vector is equal to or larger than the predetermined threshold value Th1=−Th2 in time periods T1 and T11. By compensating for only the variations exceeding the predetermined threshold value, it is possible to ignore small vibration of video data caused by, for example, a monotonous scenery around the running vehicle 1, a pedestrian near the vehicle 1, or idling of an automobile, which does not significantly affect visibility. Even if the small vibration of the video data which does not significantly affect the visibility occurs, the vibration is not compensated. Thus, the display area 21 is less likely to reach the edge of the capturing area 22.

In order to more surely detect the variations of the target object to be compensated, the compensation vector calculator 16 may operate as follows.

When a first time period and a second time are alternately repeated more than a predetermined number of times within a predetermined duration, the amount of variations of the high-frequency components of the frame vector in the first time period being equal to or more than the positive threshold value Th1, the amount of variations of the high-frequency components of the frame vector in the second time period being equal to or less than the negative threshold value Th2, the compensation vector calculator 16 calculates a compensation vector compensating for the variations. Referring to the example of FIG. 9(d), in time periods T2, T12 set to be equal to or less than the predetermined duration, a first time period in which the amount of variations is equal to or larger than the positive threshold value Th1 occurs once, and a second time period in which the amount of variations is equal to or less than the negative threshold value Th2 occurs once. After each of the time periods T2 and T12 expires, the compensation vector calculator 16 starts calculating the compensation vector.

In addition, when the absolute value of the amount of variations of the high-frequency components of the frame vector is smaller than the predetermined threshold value Th1=−Th2 for a predetermined duration, the compensation vector calculator 16 stops calculation of the compensation vector (or sets the compensation vector to zero). Referring to the example of FIG. 9(d), in time periods T3 and T13 set to the predetermined duration, the absolute value of the amount of variations of the high-frequency components of the frame vector is smaller than the predetermined threshold value Th1=−Th2. After each of the time periods T3 and T13 expires, the compensation vector calculator 16 stops calculating the compensation vector.

Therefore, in the example of FIG. 9(d), the compensation vector calculator 16 calculates a compensation vector in order to compensate for variations of the high-frequency components of the frame vector over the time periods T4 and T14.

The video compensator 17 compensates the video data using the compensation vector calculated according to FIG. 9.

The video processing system according to the first embodiment extracts the high-frequency components of the frame vector, and calculates the compensation vector compensating for the variations. Even if the vibration of the video data which does not significantly affect the visibility occurs, the vibration is not compensated. Thus, the display area 21 is less likely to reach the edge of the capturing area 22. Therefore, it is possible to compensate for the vibration in the video data captured by the video capturing apparatus 2 mounted on the vehicle 1, without requiring the excessively large capturing area 22.

In addition, since the video processing system according to the first embodiment does not require the excessively large capturing area 22, it is possible to reduce an amount of data required to compensate for variation. In addition, it is possible to effectively use pixels in the capturing area 22 of the video capturing apparatus 2, and improve the visibility of the display apparatus 4.

In addition, since the video processing system according to the first embodiment can compensate for the vibration only by video processing, without using a gyro sensor or the like, it is possible to accurately compensate for the vibration of the video data without a time lag.

In addition, since the video processing system of the first embodiment compensates for only the vibration affecting the visibility, it is possible to obtain naturally compensated video data, close to a view of naked eyes of human.

[1-3. Advantageous Effects, etc.]

The video processing apparatus and the video processing system according to the first embodiment are configured with the following features.

The video processing apparatus 3 according to the first embodiment is provided with a frame vector calculator 13, a low-frequency component extractor 14, a high-frequency component extractor 15, a compensation vector calculator 16, and a video compensator 17. The frame vector calculator 13 calculates a frame vector indicating a change in a position of a target object between frames of video data captured by a video capturing apparatus 2 mounted on a vehicle 1. The low-frequency component extractor 14 extracts low-frequency components of the frame vector, the low-frequency components indicating temporal variations of the frame vector equal to or less than a predetermined frequency “f”. The high-frequency component extractor 15 extracts high-frequency components of the frame vector, the high-frequency components indicating temporal variations of the frame vector higher than the predetermined frequency “f”, based on the low-frequency components of the frame vector. The compensation vector calculator 16 calculates a compensation vector compensating for the variations of the high-frequency components of the frame vector. The video compensator 17 compensates the video data based on the compensation vector.

Thus, it is possible to compensate for the vibration in the video data captured by the video capturing apparatus 2 mounted on the vehicle 1, without requiring an excessively large capturing area 22.

According to the video processing apparatus 3 of the first embodiment, the predetermined frequency may be 1 Hz.

Thus, it is possible to effectively eliminate vibration well perceivable and obstructive to human.

According to the video processing apparatus 3 of the first embodiment, when an absolute value of an amount of variations of the high-frequency components of the frame vector is equal to or larger than a predetermined threshold value, the video compensator 17 may compensate the video data.

Thus, even when small vibration of video data which does not significantly affect visibility occurs, the vibration is not compensated. Accordingly, the display area 21 is less likely to reach the edge of the capturing area 22.

According to the video processing apparatus 3 of the first embodiment, when a first time period and a second time period are alternately repeated a predetermined number of times within a predetermined duration, the video compensator 17 may compensate the video data. In this case, the amount of variations of the high-frequency components of the frame vector in the first time period is equal to or larger than a positive threshold value, and the amount of variations of the high-frequency components of the frame vector in the second time period is equal to or less than a negative threshold value.

Thus, it is possible to more surely detect the variations of the target object to be compensated.

The video processing system according to the first embodiment is provided with a video capturing apparatus 2, the video processing apparatus 3 according to the first embodiment, and a display apparatus that displays video data compensated by the video processing apparatus 3, and the video processing system is mounted on a vehicle 1.

Thus, it is possible to compensate for the vibration in the video data captured by the video capturing apparatus 2 mounted on the vehicle 1, without requiring an excessively large capturing area 22.

### Second Embodiment

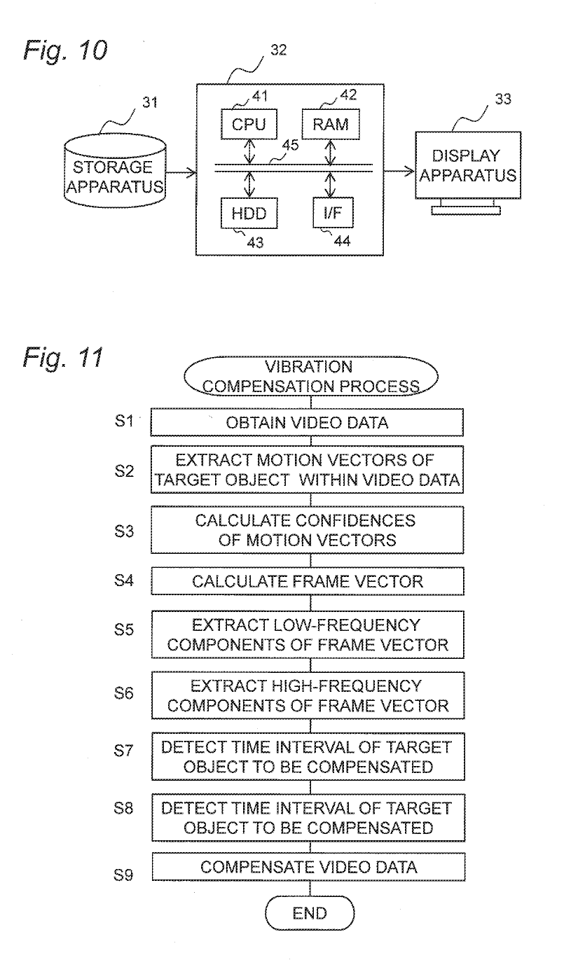

Hereinafter, with reference to FIGS. 10 and 11, a video processing system according to a second embodiment will be described.

[2-1. Configuration]

FIG. 10 is a block diagram showing a configuration of a video processing system according to the second embodiment. The video processing system of FIG. 10 is provided with a storage apparatus 31, a computer 32, and a display apparatus 33.

The storage apparatus 31 stores, in advance, video data captured by a video capturing apparatus 2 mounted on a vehicle 1 of FIG. 1.

The computer 32 is provided with a central processing unit (CPU) 41, a random access memory (RAM) 42, a hard disk drive (HDD) 43, an input/output interface (I/F) 44, and a bus 45. The CPU 41, the RAM 42, the HDD 43, and the I/F 44 are connected to each other via the bus 45. The CPU 41 reads video data from the storage apparatus 31 via the I/F 44, executes a program of vibration compensation process described later with reference to FIG. 11, and outputs compensated video data to the display apparatus 33.

The display apparatus 33 displays the video data compensated by the computer 32.

[2-2. Operation]

FIG. 11 is a flowchart showing the vibration compensation process executed by the computer 32 of FIG. 10. In step S1, the computer 32 obtains video data from the storage apparatus 31. In step S2, the computer 32 extracts motion vectors of a target object in the obtained video data. In step S3, the computer 32 calculates confidence of each of the extracted motion vectors. In step S4, the computer 32 calculates a frame vector indicating motion of an entire frame, based on the motion vectors and their confidences. In step S5, the computer 32 extracts low-frequency components of the frame vector, the low-frequency components indicating temporal variations of the frame vector with a predetermined frequency “f” or less. In step S6, the computer 32 extracts high-frequency components of the frame vector, the high-frequency components indicating temporal variations of the frame vector higher than the predetermined frequency “f”, based on the low-frequency components of the frame vector. In step S7, the computer 32 detects a time period to be compensated. In step S8, the computer 32 calculates a compensation vector compensating for variations in the high-frequency components of the frame vector. In step S9, the computer 32 compensates the video data based on the compensation vector.

Since the video processing system according to the second embodiment processes the video data stored in the storage apparatus 31, for example, it is possible to compensate for vibration of video data recorded in a drive recorder of of a running vehicle, and improve visibility of the video data.

[2-3. Advantageous Effects etc.]

The video processing system, the video processing method, and the program according to the second embodiment are configured with the following features.

The video processing system according to the second embodiment is provided with a storage apparatus 31, a computer 32, and a display apparatus 33, the storage apparatus 31 storing, in advance, video data captured by a video capturing apparatus 2 mounted on a vehicle 1 of FIG. 1.

This can improve the visibility of the video data stored in the storage apparatus 31.

The video processing method according to the second embodiment includes The method further includes calculating a frame vector indicating a change in a position of a target object between frames of video data captured by a video capturing apparatus 2 mounted on a vehicle 1. The method further includes extracting low-frequency components of the frame vector, the low-frequency components indicating temporal variations of the frame vector equal to or less than a predetermined frequency. The method further includes extracting high-frequency components of the frame vector, the high-frequency components indicating temporal variations of the frame vector higher than the predetermined frequency, based on the low-frequency components of the frame vector. The method further includes calculating a compensation vector compensating for the variations of the high-frequency components of the frame vector. The method further includes compensating the video data based on the compensation vector.

Thus, it is possible to compensate for the vibration in the video data captured by the video capturing apparatus 2 mounted on the vehicle 1, without requiring an excessively large capturing area 22.

The video processing program according to the second embodiment includes instructions executed by a computer, including the following steps. The program includes calculating a frame vector indicating a change in a position of a target object between frames of video data captured by a video capturing apparatus 2 mounted on a vehicle 1. The program includes extracting low-frequency components of the frame vector, the low-frequency components indicating temporal variations of the frame vector equal to or less than a predetermined frequency. The program includes extracting high-frequency components of the frame vector, the high-frequency components indicating temporal variations of the frame vector higher than the predetermined frequency, based on the low-frequency components of the frame vector. The program includes calculating a compensation vector compensating for the variations of the high-frequency components of the frame vector. The program includes compensating the video data based on the compensation vector.

Thus, it is possible to compensate for the vibration in the video data captured by the video capturing apparatus 2 mounted on the vehicle 1, without requiring an excessively large capturing area 22.

### Other Embodiments

As described above, the first and second embodiments have been described as examples of the technique disclosed in the present application. However, the technique of the present disclosure is not limited thereto, and can also be applied to embodiments with appropriate changes, substitutions, additions, omissions, etc. In addition, it is also possible to combine the respective constituent elements described in the first and second embodiments to provide a new embodiment.

Then, other embodiments will be exemplified below.

In the above embodiment, the predetermined frequency of about 1 Hz is set in order to extract the low-frequency components by the low-frequency component extractor 14, and extract the high-frequency components by the high-frequency component extractor 15. However, the predetermined frequency is not limited to this frequency, and may be a frequency of any vibration well perceivable and obstructive to human. For example, vibration of 1 to 2 Hz or more in a horizontal direction, and vibration of 4 to 12.5 Hz or more in a vertical direction is well perceivable to human. In addition, at 3 to 4 Hz or more, vertical vibration is more perceivable than horizontal vibration. Therefore, different frequencies may be set for the horizontal vibration, the vertical vibration, and rotational vibration.

The video processing system may be mounted on not only the vehicle 1 such as an automobile, but may be mounted on any other vehicle.

The first and second embodiments may be combined. For example, the computer 32 of FIG. 10 may be used instead of the video processing apparatus 3 of FIG. 1. In addition, the video processing apparatus 3 of FIG. 1 implemented by dedicated hardware may be used instead of the computer 32 of FIG. 10.

As described above, the embodiments have been described as examples of the technique of the present disclosure. To that end, the accompanying drawings and the detailed description are provided.

Accordingly, the constituent elements described in the accompanying drawings and the detailed description may include not only constituent elements essential to solving the problem, but also constituent elements not essential to solving the problem, in order to exemplify the technique. Therefore, even when those non-essential constituent elements are described in the accompanying drawings and the detailed description, those non-essential constituent elements should not be considered essentials.

In addition, since the above-described embodiments are intended to exemplify the technique of the present disclosure, it is possible to make various changes, replacements, additions, omissions, etc. within the scope of claims or the equivalent thereof.

An aspect of the present disclosure can be used as a video processing system for an in-vehicle camera, and in addition, can be used to process video data captured and recorded by the in-vehicle camera.

1. An video processing apparatus comprising:
a frame vector calculator that calculates a frame vector indicating a change in a position of a target object between frames of video data captured by a video capturing apparatus mounted on a vehicle;
a low-frequency component extractor that extracts low-frequency components of the frame vector, the low-frequency components indicating temporal variations of the frame vector equal to or less than a predetermined frequency;
a high-frequency component extractor that extracts high-frequency components of the frame vector, the high-frequency components indicating temporal variations of the frame vector higher than the predetermined frequency, based on the low-frequency components of the frame vector;
a compensation vector calculator that calculates a compensation vector compensating for the variations of the high-frequency components of the frame vector; and
a video compensator that compensates the video data based on the compensation vector.

2. The video processing apparatus as claimed in claim 1,
wherein the predetermined frequency is 1 Hz.

3. The video processing apparatus as claimed in claim 1,
wherein, when an absolute value of an amount of variations of the high-frequency components of the frame vector is equal to or larger than a predetermined threshold value, the video compensator compensates the video data.

4. The video processing apparatus as claimed in claim 3,
wherein, when a first time period and a second time period are alternately repeated a predetermined number of times within a predetermined duration, the amount of variations of the high-frequency components of the frame vector in the first time period being equal to or larger than a positive threshold value, and the amount of variations of the high-frequency components of the frame vector in the second time period being equal to or less than a negative threshold value, the video compensator compensates the video data.

5. An video processing system comprising:
a video capturing apparatus;
a video processing apparatus; and
a display apparatus that displays video data compensated by the video processing apparatus,
wherein the video processing apparatus comprises:
a frame vector calculator that calculates a frame vector indicating a change in a position of a target object between frames of video data captured by a video capturing apparatus mounted on a vehicle;
a low-frequency component extractor that extracts low-frequency components of the frame vector, the low-frequency components indicating temporal variations of the frame vector equal to or less than a predetermined frequency;
a high-frequency component extractor that extracts high-frequency components of the frame vector, the high-frequency components indicating temporal variations of the frame vector higher than the predetermined frequency, based on the low-frequency components of the frame vector;
a compensation vector calculator that calculates a compensation vector compensating for the variations of the high-frequency components of the frame vector; and
a video compensator that compensates the video data based on the compensation vector, and
wherein the video processing system is mounted on a vehicle.

6. An video processing method comprising:
calculating a frame vector indicating a change in a position of a target object between frames of video data captured by a video capturing apparatus mounted on a vehicle;
extracting low-frequency components of the frame vector, the low-frequency components indicating temporal variations of the frame vector equal to or less than a predetermined frequency;
extracting high-frequency components of the frame vector, the high-frequency components indicating temporal variations of the frame vector higher than the predetermined frequency, based on the low-frequency components of the frame vector;
calculating a compensation vector compensating for the variations of the high-frequency components of the frame vector, and
compensating the video data based on the compensation vector.

7. A program including instructions executed by a computer comprising:
calculating a frame vector indicating a change in a position of a target object between frames of video data captured by a video capturing apparatus mounted on a vehicle;
extracting low-frequency components of the frame vector, the low-frequency components indicating temporal variations of the frame vector equal to or less than a predetermined frequency;
extracting high-frequency components of the frame vector, the high-frequency components indicating temporal variations of the frame vector higher than the predetermined frequency, based on the low-frequency components of the frame vector;
calculating a compensation vector compensating for the variations of the high-frequency components of the frame vector, and
compensating the video data based on the compensation vector.
